(19) United States
(12) Patent Application Publication
(10) Pub. No.: US 2016/0313201 A1
(43) Pub. Date: Oct. 27, 2016

(54) PRESSURE SENSOR PACKAGE

(71) Applicant: Samsung Electro-Mechanics Co., Ltd., Suwon-si (KR)

(72) Inventors: Tae Hun LEE, Suwon-si (KR); Chang Hyun LIM, Suwon-si (KR); Dae Hun JEONG, Suwon-si (KR)

(73) Assignee: Samsung Electro-Mechanics Co., Ltd., Suwon-si (KR)

(21) Appl. No.: 14/990,317

(22) Filed: Jan. 7, 2016

(30) Foreign Application Priority Data
Apr. 23, 2015 (KR) 10-2015-0057012

(51) Int. Cl. G01L 9/02

(52) U.S. Cl. CPC G01L 9/02

(57) ABSTRACT

A pressure sensor package includes a substrate, a pressure sensor, and a semiconductor circuit. The semiconductor circuit is disposed on one surface of the substrate and having a reception space open to one surface of the substrate. A pressure sensor is connected to the substrate and disposed in the reception space.

### CROSS-REFERENCE TO RELATED APPLICATION(S)

This application claims the benefit of Korean Patent Application No. 10-2015-0057012 filed on Apr. 23, 2015 in the Korean Intellectual Property Office, the entire disclosure of which is incorporated herein by reference for all purposes.

### BACKGROUND

1. Field

The following description relates to a pressure sensor package capable of being easily mounted in a small terminal.

2. Description of Related Art

A pressure sensor package may be mounted in many different types of devices. As an example, a pressure sensor package may be mounted in a vehicle. As another example, a pressure sensor package may be mounted in a small portable terminal.

In the former case, there are very little spatial limitations, and thus the pressure sensor package may be easily mounted. Conversely, in the latter case, spatial limitation is a significant issue, and thus the pressure sensor package is not easily mounted.

Therefore, there is a need to develop a pressure sensor package that may be easily mounted in small portable terminals.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a general aspect, a pressure sensor package includes a substrate; a semiconductor circuit disposed on one surface of the substrate and having a reception space open to one surface of the substrate; and a pressure sensor connected to the substrate and disposed in the reception space.

A hole may be formed in the substrate so that the pressure sensor measures pressure formed on the other surface of the substrate.

The reception space may extend longitudinally in a length direction of the substrate.

The semiconductor circuit may include via electrodes connected to circuits of the substrate.

The pressure sensor package may further include a support member connected to the substrate; and a connection member connecting the support member and the pressure sensor to each other.

The pressure sensor may be coupled via a connection member to a support member, the support member may include a groove formed substantially along a circumference of the pressure sensor so that the pressure sensor and a support member are separated from each other.

At least one of the connection member or the support member may include a metal film formed thereon, the metal film configured to enable an electrical connection between the pressure sensor and the substrate.

The pressure sensor package may further include a cover member disposed on one surface of the substrate to substantially cover the semiconductor circuit.

The semiconductor circuit may include an application specific integrated circuit (ASIC) complementing a function of the pressure sensor.

According to another general aspect, a pressure sensor package includes a substrate having a first reception space formed in one surface thereof; a semiconductor circuit disposed on one surface of the substrate and having a second reception space formed therein, the second reception space facing the first reception space; and a pressure sensor connected to the substrate and disposed between the first reception space and the second reception space.

According to another general aspect, a pressure sensor package includes a substrate; and, a pressure sensor. The pressure sensor is mounted in a deformable member which is disposed on the substrate. The deformable member is configured to receive and attenuate mechanical force.

The substrate may have a through-hole defined therethrough and the pressure sensor mounted thereabove and configured to measure a pressure external thereto.

The deformable member may include at least one electrical circuit path configured to operably couple the pressure sensor with a connection point on the substrate.

Other features and aspects will be apparent from the following detailed description, the drawings, and the claims.

### BRIEF DESCRIPTION OF THE DRAWINGS

The above and other aspects, features, and advantages of the present disclosure will be more clearly understood from the following detailed description taken in conjunction with the accompanying drawings, in which:

FIG. 1 is a cross-sectional view of a pressure sensor package according to an exemplary embodiment.

FIG. 2 is an enlarged cross-sectional view of part A illustrated in FIG. 1.

FIG. 3 is a cross-sectional view take along line B-B of FIG. 1.

FIG. 4 is a cross-sectional view of the pressure sensor package in a state in which external impact is applied to the pressure sensor package.

FIG. 5 is a cross-sectional view of a pressure sensor package according to another exemplary embodiment.

FIG. 6 is a cross-sectional view of a pressure sensor package according to another exemplary embodiment.

FIG. 7 is a cross-sectional view of the pressure sensor package take along line C-C of FIG. 6.

FIG. 8 is a cross-sectional view of a pressure sensor package according to another exemplary embodiment.

FIG. 9 is a cross-sectional view of the pressure sensor package in a state in which external impact is applied to the pressure sensor package.

FIG. 10 is a cross-sectional view of a pressure sensor package according to another exemplary embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

In the drawings, the shapes and dimensions of elements may be exaggerated for clarity, and the same reference numerals will be used throughout to designate the same or like elements.

A pressure sensor package may be mounted in a small portable terminal. As an example, the pressure sensor package may be mounted in a portable wireless terminal.

The pressure sensor package has been gradually miniaturized and thinned so that it may be easily mounted in the portable wireless terminal. As an example, the pressure sensor package may be manufactured in a form in which a semiconductor circuit and a pressure sensor assembly are integrated with each other by a monolithic micro electro-mechanical systems (MEMS) scheme. In the above-mentioned scheme, a pressure sensor package having reduced height may be implemented. However, in the above-mentioned scheme, a manufacturing yield of the pressure sensor package is very low, and an area of the pressure sensor package is increased.

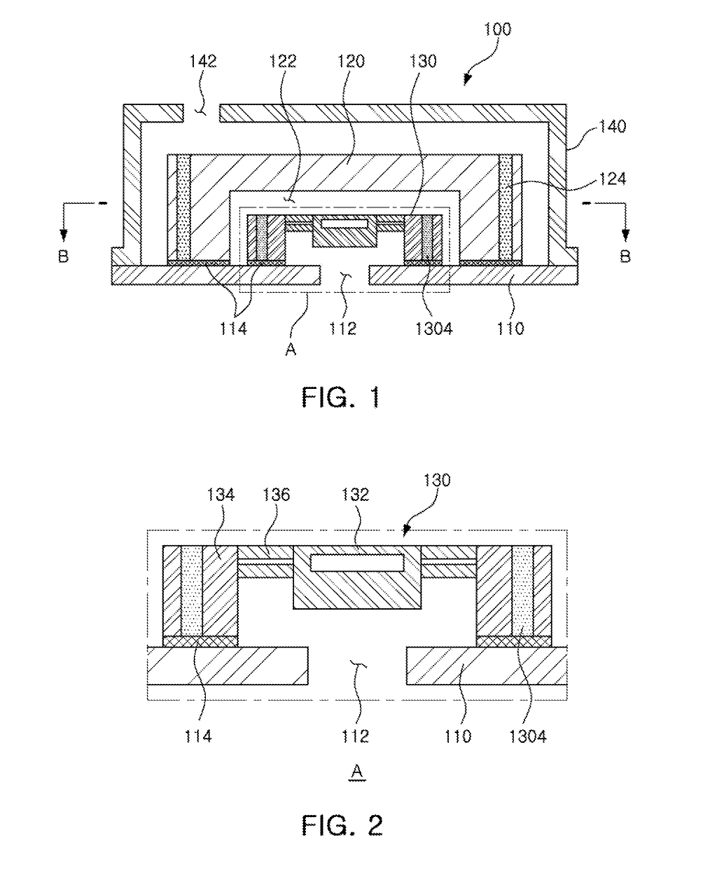

A pressure sensor package according to an exemplary embodiment in the present disclosure will be described with reference to FIG. 1.

A pressure sensor package 100 includes a substrate 110. As an example, the pressure sensor package 100 may include the substrate 110 electrically connected to a main board of a terminal.

The substrate 110 includes one or more boards on which circuits 114 are formed. As an example, the substrate 110 may have a form in which a first board having a first circuit printed thereon and a second board having a second circuit printed thereon are stacked. As another example, the substrate 110 may have a form in which a first board having a first circuit printed thereon, a second board having a via electrode formed thereon, and a third board having a second circuit printed thereon are sequentially stacked.

The substrate 110 has a hole 112 formed therein. As an example, one or more holes 112 connected from one surface of the substrate 110 to the other surface of the substrate 110 may be formed through the substrate 110.

The pressure sensor package 100 includes a semiconductor circuit 120. As an example, the pressure sensor package 100 includes the semiconductor circuit 120 processing a pre-processed electrical signal.

The semiconductor circuit 120 may have an application specific integrated circuit (ASIC) form. As an example, the semiconductor circuit 120 may be a semiconductor designed to be compatible with a terminal in which it is to be mounted. The semiconductor circuit 120 is connected to the substrate 110. As an example, the semiconductor circuit 120 is electrically connected to the circuits 114 of the substrate 110.

The semiconductor circuit 120 may include via electrodes 124 for electrical connection. As an example, one or more via electrodes 124 length-wise extended in a height direction may be formed in the semiconductor circuit 120. The via electrodes 124 are connected to the circuits 114 of the substrate 110.

The semiconductor circuit 120 includes a reception space 122. As an example, the reception space 122 having a predetermined size may be formed in a lower surface (in FIG. 1) of the semiconductor circuit 120. The reception space 122 formed as described above may provide a space in which an electronic component may be mounted between the semiconductor circuit 120 and the substrate 110.

The reception space 122 may be formed at the center of the semiconductor circuit 120. As an example, the reception space 122 may have a form in which an upper portion and four lateral sides thereof are enclosed by the semiconductor circuit 120. The form of the reception space 122 described above may allow the electronic component disposed in the reception space 122 to be protected by the semiconductor circuit 120.

The pressure sensor package 100 may include a pressure sensor assembly 130. As an example, the pressure sensor package 100 may include the pressure sensor assembly 130 measuring pressure in the vicinity of the terminal.

The pressure sensor assembly 130 is disposed between the substrate 110 and the semiconductor circuit 120. As an example, the pressure sensor assembly 130 may be disposed in the reception space 122.

The pressure sensor assembly 130 is connected to the substrate 110. As an example, via electrodes 1304 of the pressure sensor assembly 130 are connected to the circuits 114 of the substrate 110. The pressure sensor assembly 130 is connected to the semiconductor circuit 120. As an example, the pressure sensor assembly 130 may be connected to the semiconductor circuit 120 through the circuits 114 of the substrate 110.

The pressure sensor assembly 130 configured as described above may convert a measured pressure value into an electrical signal and transfer the electrical signal to the semiconductor circuit 120 and the substrate 110.

The pressure sensor package 100 may include a cover member 140. As an example, the pressure sensor package 100 includes the cover member 140 disposed on the substrate 110.

The cover member 140 covers at least a portion of the semiconductor circuit 120. As an example, the cover member 140 may be a polyhedron covering an upper surface and side surfaces of the semiconductor circuit 120. The cover member 140 shields against harmful electromagnetic waves. As an example, the cover member 140 may be formed of a metal that may shield against harmful electromagnetic waves. As another example, the cover member 140 may be formed of a resin. In this case, a metal may be applied onto a surface of the cover member 140.

One or more holes 142 may be formed in the cover member 140. As an example, the hole 142 may be formed in an upper surface of the cover member 140. The hole 142 may be used as a path through which external air of the cover member 140 is introduced into the cover member 140. Therefore, an inner portion of the cover member 140 may be maintained in the same pressure state as that of an outer portion of the cover member 140.

The pressure sensor assembly 130 of the pressure sensor package 100 according to an exemplary embodiment will be described with reference to FIG. 2.

The pressure sensor assembly 130 is disposed on the substrate 110. As an example, the pressure sensor assembly 130 is disposed on the substrate 110 to face the hole 112 defined through the substrate 110. External air of the substrate 110 may be introduced through the hole 112 of the substrate 110. Therefore, the vicinity of the pressure sensor assembly 130 may be in the same pressure state as that of an outer portion of the substrate 110.

The pressure sensor assembly 130 includes a pressure sensor 132, a support member 134, and a connection member 136. However, the pressure sensor assembly 130 is not limited to only the above-mentioned members. As an example, the pressure sensor assembly 130 includes a connection pad member for electrical connection to the substrate 110.

The pressure sensor 132 may measure surrounding pressure. As an example, the pressure sensor 132 includes a sealed room contracted or expanded depending on a magnitude of surrounding pressure. A piezoresistor or a piezoelectric element may be disposed in the vicinity of the sealed room to convert a deformation level of the sealed room into an electrical signal.

The support member 134 may be connected to the substrate 110. As an example, the support member 134 is electrically connected to the substrate 110 through the via electrodes 1304 and contacts 114. The support member 134 may have a form in which it encloses the pressure sensor 132. As an example, the support member 134 may have a quadrangular shape in which it encloses four sides of the pressure sensor 132.

The connection member 136 connects the pressure sensor 132 and the support member 134 to each other. As an example, a pair of connection members 136 may be length-wise extended from opposing side surfaces of the pressure sensor 132 to the support member 134. As another example, a plurality of connection members 136 may be longitudinally extended from four side surfaces of the pressure sensor 132 to the support member 134.

The connection member 136 may electrically connect the pressure sensor 132 and the support member 134 to each other. As an example, a circuit electrically connecting the pressure sensor 132 and the via electrodes 1304 of the support member 134 to each other may be formed on the connection member 136.

The connection member 136 may be elastically deformed. As an example, the connection member 136 may be freely bent by external force applied thereto. The connection member 136 configured as described above may decrease a phenomenon that the pressure sensor 132 is damaged due to impact applied to the pressure sensor package 100.

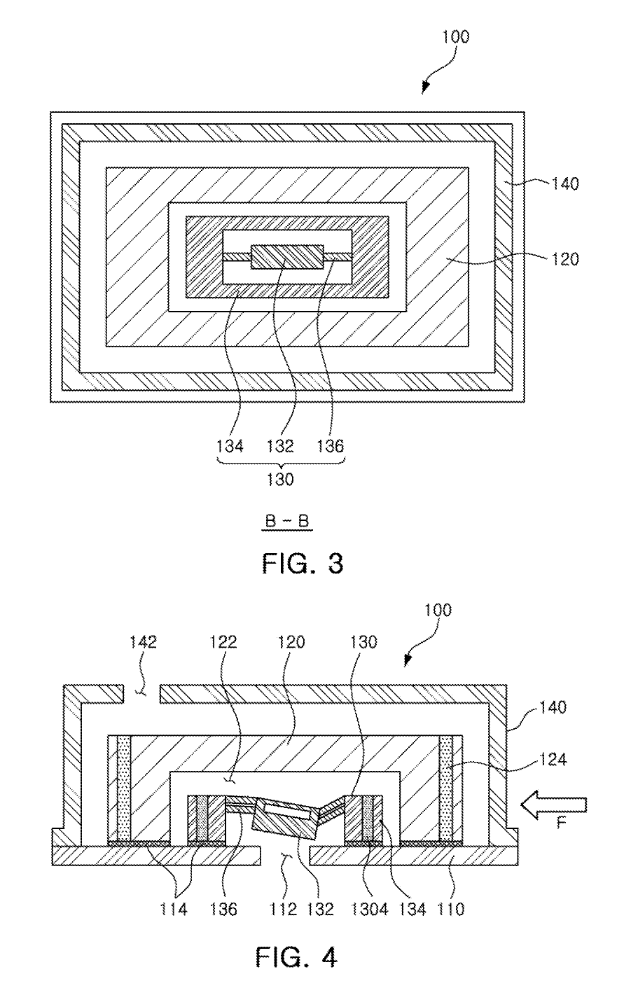

The pressure sensor package according to an exemplary embodiment will be described with reference to FIG. 3. For reference, FIG. 3 is a cross-sectional view of the pressure sensor package taken along line B-B.

The pressure sensor package 100 according to the present exemplary embodiment may have a form in which the pressure sensor assembly 130 is received in the semiconductor circuit 120. Therefore, the pressure sensor package 100 according to the present exemplary embodiment may be advantageous in integration of a package.

The pressure sensor package 100 according to the present exemplary embodiment has a form in which the pressure sensor 132 is enclosed by the support member 134. Therefore, in the pressure sensor package 100 according to the present exemplary embodiment, a phenomenon that external impact is transferred to the pressure sensor 132 may be decreased.

The pressure sensor package 100 according to the present exemplary embodiment may have a form in which the semiconductor circuit 120 and the pressure sensor assembly 130 are covered by the cover member 140. Therefore, in the pressure sensor package 100 according to the present exemplary embodiment, the semiconductor circuit 120 and the pressure sensor assembly 130 may be protected from harmful electromagnetic waves. In addition, in the pressure sensor package 100 according to the present exemplary embodiment, direct transfer of external impact to the semiconductor circuit 120 and the pressure sensor assembly 130 may be blocked by the cover member 140.

In the pressure sensor package 100 according to the present exemplary embodiment, reliability of an operation of the pressure sensor 132 may be secured. As an example, the pressure sensor package 100 according to the present exemplary embodiment may have a structure that may absorb external impact.

An impact absorbing structure of the pressure sensor package according to an exemplary embodiment will be described with reference to FIG. 4.

Since portable terminals generally have a compact size, it may be easy for users to carry portable terminals. Conversely, it may be easy for users to drop portable terminals due to carelessness. In this case, impact may also be applied to the pressure sensor package 100 mounted in the portable terminal. As an example, force F having a significant magnitude may act on the pressure sensor package 100 from one side of the pressure sensor package 100, as illustrated in FIG. 4, when the portable terminal is dropped.

Conventionally, such a force F may be transferred to the semiconductor circuit 120 and the pressure sensor assembly 130 to cause defects of the semiconductor circuit 120 and the pressure sensor assembly 130. Particularly, since the pressure sensor assembly 130 is a component sensitive to external impact, this force F may decrease reliability of measurement of the pressure sensor assembly 130.

However, in the pressure sensor package 100 according to the present exemplary embodiment, the connection member 136 may be deformed (for example, bent or twisted) to offset a magnitude of the force F applied to the pressures sensor member 132. Therefore, in the pressure sensor package 100 according to the present exemplary embodiment, reliability of an operation of the pressure sensor assembly 130 may be maintained even in a case in which external impact is applied to the pressure sensor package.

Next, other exemplary embodiments will be described.

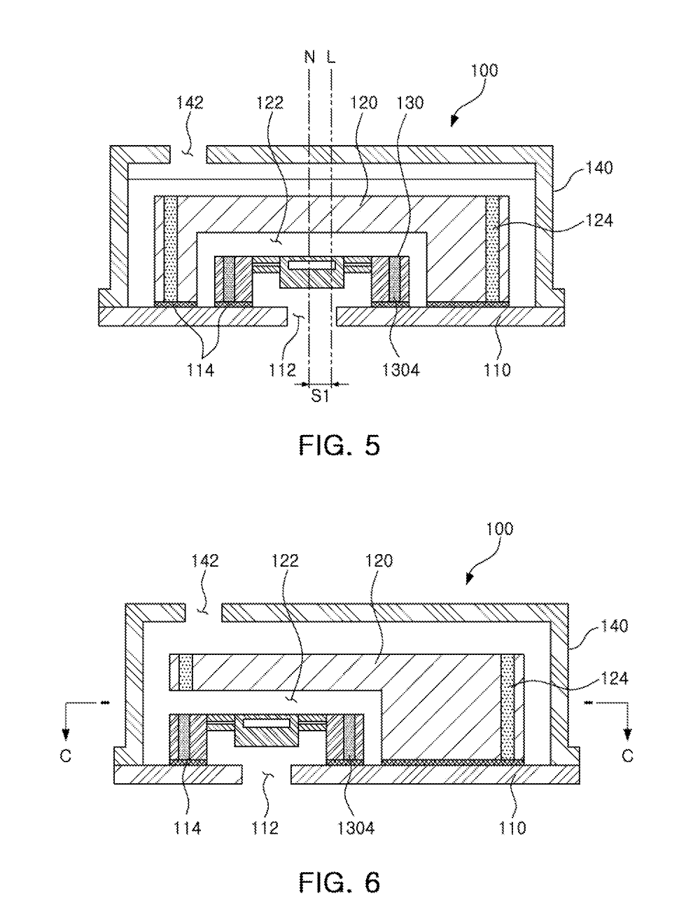

A pressure sensor package according to another exemplary embodiment will be described with reference to FIG. 5.

The pressure sensor package 100 according to the present exemplary embodiment may be different in a disposition form of a pressure sensor assembly 130 from the pressure sensor package according to the exemplary embodiment described above. As an example, in the pressure sensor package 100 according to the present exemplary embodiment, the pressure sensor assembly 130 may be disposed to be biased toward one side from a central bisector of the pressure sensor package 100. For example, a space S1 having a predetermined size may be formed between a bisector N of the pressure sensor assembly 130 and a bisector L of the semiconductor circuit 120.

The disposition form of the pressure sensor assembly 130 as described above may be advantageous in a case in which the reception space 112 may not be formed at the center of the semiconductor circuit 120.

A pressure sensor package according to another exemplary embodiment will be described with reference to FIG. 6.

The pressure sensor package 100 according to the present exemplary embodiment may be different in a shape of a semiconductor circuit 120 from the pressure sensor packages according to the exemplary embodiments described above. As an example, in the pressure sensor package 100 according to the present exemplary embodiment, the semiconductor circuit 120 has a reception space 112 opened to a lower surface and one side surface thereof.

The pressure sensor package 100 according to the present exemplary embodiment may be different in a disposition form of a pressure sensor assembly 130 from the pressure sensor packages according to the exemplary embodiments described above. As an example, in the pressure sensor package 100 according to the present exemplary embodiment, the pressure sensor assembly 130 may be disposed to be biased toward one side. For example, one side surface of the pressure sensor assembly 130 may be disposed to be collinear with one side surface of the semiconductor circuit 120.

The offset disposition form of the pressure sensor assembly 130 as described above may be advantageous in the case in which the reception space 112 may not be formed at the center of the semiconductor circuit 120.

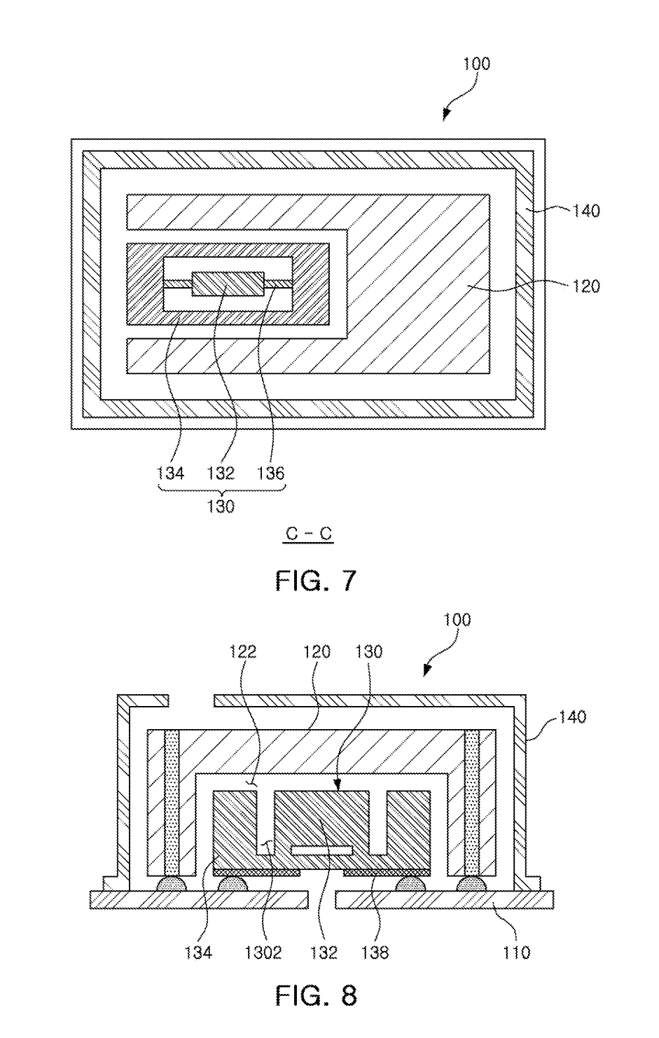

A cross-sectional shape of the pressure sensor package described above will be described with reference to FIG. 7. For reference, FIG. 7 is a cross-sectional view of the pressure sensor package taken along line C-C.

In the pressure sensor package 100 according to the present exemplary embodiment, the pressure sensor assembly 130 may be disposed to be biased toward one side of the semiconductor circuit 120, as described above with reference to FIG. 6. As an example, one side surface of the pressure sensor assembly 130 may be disposed to be coplanar with one side surface of the semiconductor circuit 120. As another example, a portion of the pressure sensor assembly 130 may be disposed to protrude outwardly of the semiconductor circuit 120.

In the pressure sensor package 100 configured as described above, a size of the reception space 112 in which the pressure sensor assembly 130 is received may be decreased, and thus a degree of freedom of a design of the semiconductor circuit 120 may be increased.

A pressure sensor package according to another exemplary embodiment will be described with reference to FIG. 8.

The pressure sensor package 100 according to the present exemplary embodiment may be different in a form of a pressure sensor assembly 130 from the pressure sensor packages according to the exemplary embodiments described above. As an example, the pressure sensor assembly 130 may be integrally manufactured in a monolithic MEMS scheme.

The pressure sensor assembly 130 includes a pressure sensor 132 and a support member 134. Here, the pressure sensor 132 is disposed to face a hole 112 of the substrate 110, and the support member 134 may be disposed to enclose the pressure sensor 132. A groove 1302 may be formed between the pressure sensor 132 and the support member 134. The groove 1302 may be used as a buffering space preventing collision between the pressure sensor 132 and the support member 134.

In the pressure sensor package 100 configured as described above, the pressure sensor assembly 130 may be integrally manufactured in the monolithic MEMS scheme, and thus a manufacturing yield of the pressure sensor package 100 may be improved.

A connection pad 138 or a metal film connect the pressure sensor assembly 130 and the substrate 110 to each other.

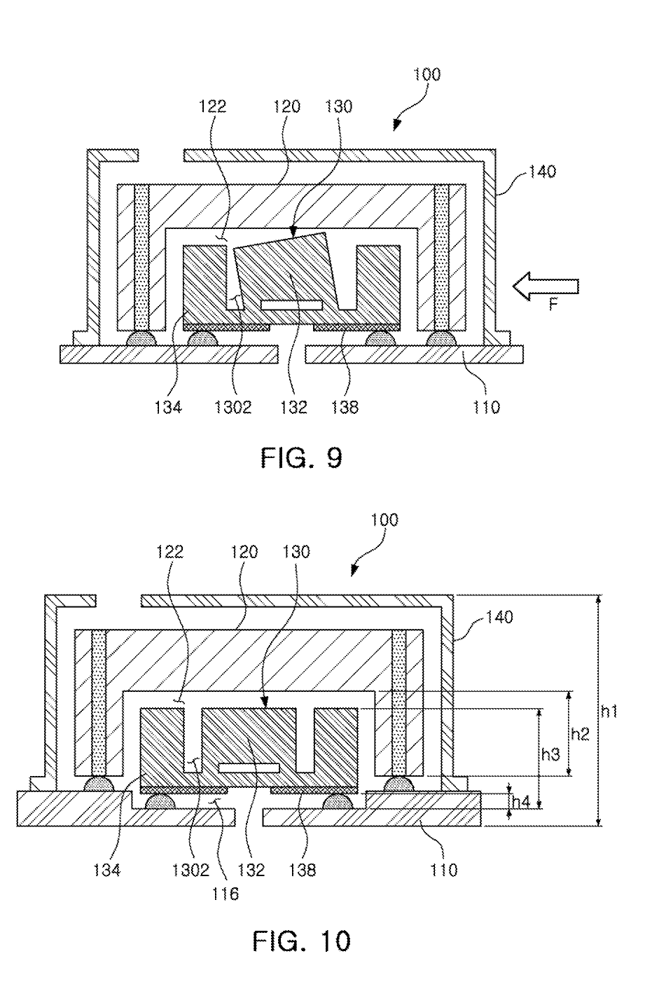

An impact absorbing structure of the pressure sensor package according to another exemplary embodiment will be described with reference to FIG. 9.

The pressure sensor package 100 according to the present exemplary embodiment may absorb impact through the groove 1302 of the pressure sensor assembly 130. As an example, force F applied to the pressure sensor package 100 may be used to deform an area around the pressure sensor 132 or the support member 134 and then be attenuated to avoid damaging the pressure sensor 132.

A pressure sensor package according to another exemplary embodiment will be described with reference to FIG. 10.

The pressure sensor package 100 according to the present exemplary embodiment may be different in a form of a substrate 110 from the pressure sensor packages according to the exemplary embodiments described above. As an example, the substrate 110 of the pressure sensor package 100 according to the present exemplary embodiment may have a first reception space 116.

The first reception space 116 may be disposed to face a second reception space 122 of the semiconductor circuit 120. Therefore, the first reception space 116 and the second reception space 122 may form one space when the substrate 110 and the semiconductor circuit 120 are brought together. The pressure sensor assembly 130 may be disposed in this space. As an example, a portion of the pressure sensor assembly 130 may be received in the first reception space 116, and the remaining portion thereof may be received in the second reception space 122. In addition, the space may have a size at which it may receive the pressure sensor assembly 130. As an example, the sum (h4+h2) of a depth h4 of the first reception space 116 and a depth h2 of the second reception space 122 may be substantially larger than a height h3 of the pressure sensor assembly 130.

In the pressure sensor package 100 configured as described above, the space in which the pressure sensor assembly 130 is received may be formed by the substrate 110 and the semiconductor circuit 120, which is advantageous in lowering an entire height h1 of the pressure sensor package 100.

As set forth above, according to an exemplary embodiment, the pressure sensor package may be easily mounted in a small portable terminal while retaining a thinness of the small portable terminal.

The apparatuses, units, modules, devices, and other components (e.g., the substrate 110, pressure sensor package 100, cover member 140, pressure sensor assembly 130, and pressure sensor 132) illustrated in FIGS. 1-10 that perform the operations described herein are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described herein are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As a non-exhaustive example only, a mobile terminal as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

While exemplary embodiments have been shown and described above, it will be apparent to those skilled in the art that modifications and variations could be made without departing from the scope of the present invention as defined by the appended claims.

What is claimed is:

1. A pressure sensor package comprising:
a substrate;
a semiconductor circuit disposed on one surface of the substrate and having a reception space open to one surface of the substrate; and
a pressure sensor connected to the substrate and disposed in the reception space.

2. The pressure sensor package of claim 1, wherein a hole is formed in the substrate so that the pressure sensor measures pressure formed on the other surface of the substrate.

3. The pressure sensor package of claim 1, wherein the reception space is longitudinally extended in a length direction of the substrate.

4. The pressure sensor package of claim 1, wherein the semiconductor circuit includes via electrodes connected to circuits of the substrate.

5. The pressure sensor package of claim 1, further comprising
a support member connected to the substrate; and
a connection member connecting the support member and the pressure sensor to each other.

6. The pressure sensor package of claim 1, wherein the pressure sensor is coupled via a connection member to a support member, the support member including a groove formed substantially along a circumference of the pressure sensor so that the pressure sensor and a support member are separated from each other.

7. The pressure sensor package of claim 1, wherein at least one of the connection member or the support member includes a metal film formed thereon, the metal film configured to enable an electrical connection between the pressure sensor and the substrate.

8. The pressure sensor package of claim 1, further comprising a cover member disposed on one surface of the substrate to substantially cover the semiconductor circuit.

9. The pressure sensor package of claim 1, wherein the semiconductor circuit includes an application specific integrated circuit (ASIC) complementing a function of the pressure sensor.

10. A pressure sensor package comprising:
a substrate having a first reception space formed in one surface thereof;
a semiconductor circuit disposed on one surface of the substrate and having a second reception space formed therein, the second reception space facing the first reception space; and
a pressure sensor connected to the substrate and disposed between the first reception space and the second reception space.

11. The pressure sensor package of claim 10, wherein a hole is formed in the substrate so that the pressure sensor measures pressure formed on the other surface of the substrate.

12. The pressure sensor package of claim 10, wherein the semiconductor circuit includes via electrodes connected to circuits of the substrate.

13. The pressure sensor package of claim 10, further comprising a support member connected to the substrate; and
a connection member connecting the support member and the pressure sensor to each other.

14. The pressure sensor package of claim 10, wherein the pressure sensor is coupled via a connection member to a support member, the support member including a groove formed substantially along a circumference of the pressure sensor so that the pressure sensor and a support member are separated from each other.

15. The pressure sensor package of claim 10, wherein at least one of the connection member or the support member includes a metal film formed thereon, the metal film configured to enable an electrical connection between the pressure sensor and the substrate.

16. The pressure sensor package of claim 10, further comprising a cover member disposed on one surface of the substrate to substantially cover the semiconductor circuit.

17. The pressure sensor package of claim 10, wherein the semiconductor circuit includes an application specific integrated circuit (ASIC) complementing a function of the pressure sensor.

18. A pressure sensor package comprising:
a substrate; and,
a pressure sensor mounted in a deformable member disposed on the substrate, the deformable member configured to receive and attenuate mechanical force.

19. The pressure sensor package of claim 18, wherein the substrate has a through-hole defined therethrough and the pressure sensor is mounted thereabove and configured to measure a pressure external thereto.

20. The pressure sensor package of claim 19, wherein the deformable member includes at least one electrical circuit path configured to operably couple the pressure sensor with a connection point on the substrate.
